(19) United States
(12) Patent Application Publication
(10) Pub. No.: US 2010/0146018 A1
(43) Pub. Date: Jun. 10, 2010

(54) METHOD FOR CONSTRUCTING A FILE FORMAT AND APPARATUS FOR PROCESSING A DIGITAL BROADCASTING SIGNAL INCLUDING A FILE HAVING THE FILE FORMAT AND METHOD THEREOF

(75) Inventor: Jeong Woo Kim, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 12/449,177

(22) PCT Filed: Jan. 25, 2008
(86) PCT No.: PCT/KR2008/000482

§ 371 Date: Jan. 22, 2010

(30) Foreign Application Priority Data
Jan. 26, 2007 (KR) 10-2007-0008636

(51) Int. Cl. G06F 17/30; H04N 7/04

(52) U.S. Cl. 707/822; 348/469; 348/E07.04; 707/E17.01; 707/E17.009

(57) ABSTRACT

A method for constructing a file format, and an apparatus for processing a digital broadcasting signal including a file having the file format and a method thereof are disclosed. A method for constructing a multimedia application format (MAF) file format is characterized in that the MAF file format comprises a plurality of boxes, i.e., a first box indicating a type or version of a file for the file format, a second box including at least one track box and describing presentation of a scene including the track box, the track box including description for one media, and a third box including real contents described by each track box. Accordingly, it is possible to construct a file format most suitable for a type of a corresponding file and properly process the file format in the receiver.

### TECHNICAL FIELD

The present invention relates to a method for constructing a file format, and an apparatus for processing a digital broadcasting signal including a file having the file format and a method thereof.

### BACKGROUND ART

A recent broadcasting environment is rapidly changing from an existing analog broadcasting environment to a digital broadcasting environment.

Due to such a change of broadcasting environment, it has come to the situation that the existing file type or file format fails to transmit and receive data. In this respect, it is necessary to construct a new file type or a new file format. An example of the file format includes a multimedia application format (MAF).

The multimedia application format (MAF) can have formats constructed variously depending on definition of corresponding standardization.

The multimedia application format (MAF) is generally expressed by boxes, each of which can be defined in corresponding standardization.

However, at present, the multimedia application format (MAF) fails to cover all broadcasting types. For example, a multimedia application format (MAF) for digital multimedia broadcasting has not been defined yet. Therefore, it is necessary to construct the multimedia application format (MAF) for digital multimedia broadcasting.

### DISCLOSURE OF INVENTION

### Technical Problem

An object of the present invention is to construct a multimedia application format (MAF) for digital multimedia broadcasting.

Another object of the present invention is to provide a method and apparatus for processing the constructed multimedia application format (MAF).

Another object of the present invention is to provide a simple and efficient structure which is the most suitable for a corresponding broadcasting type in constructing the multimedia application format (MAF).

### Technical Solution

To achieve the object and other advantages and in accordance with the purpose of the invention, as embodied and broadly described herein, a method for constructing a multimedia application format (MAF) file format is characterized in that the MAF file format comprises a plurality of boxes, i.e., a first box indicating a type or version of a file for the file format, a second box including at least one track box and describing presentation of a scene including the track box, the track box including description for one media, and a third box including real contents described by each track box.

In another aspect of the present invention, a method for constructing a multimedia application format (MAF) file format, is characterized in that the MAF file format comprises a plurality of boxes, i.e., a first box indicating a type or version of a file for the file format, a second box including a plurality of track boxes and describing presentation of a scene including the plurality of track boxes, the track boxes including description for one media, and a third box including a plurality of objects described by each track box in the second box.

In still another aspect of the present invention, a method for processing a digital broadcasting signal comprises: receiving and storing a digital broadcasting signal including at least one file having a multimedia application format (MAF) file format constructed to include a first box indicating a type or version of a corresponding file, a second box including at least one track and describing presentation of a scene including a corresponding track, and a third box storing specific data designated by the corresponding track in the second box; reading out a desired file from the stored files and decoding and extracting media data in the corresponding file; generating specific data by decoding depending on properties of the extracted media data; and processing and outputting the generated specific data.

In further still another aspect of the present invention, a method for processing a digital broadcasting signal comprises: receiving and storing a digital broadcasting signal including at least one file having a multimedia application format (MAF) file format constructed to include a first box indicating a type or version of a corresponding file, a second box including a plurality of tracks and describing presentation of a scene including each track, a third box storing a plurality of data objects designated by each track in the second box, and a fourth box including meta data of each data object stored in the third box; requesting a specific data object in the stored files with reference to the meta data in the fourth box; generating specific data by receiving the specific data object according to the request; and decoding and outputting the generated specific data.

In further still another aspect of the present invention, a digital broadcasting receiver comprises: a storage medium receiving and storing a digital broadcasting signal including at least one file having a multimedia application format (MAF) file format constructed to include a first box indicating a type or version of a corresponding file, a second box including at least one track and describing presentation of a scene including a corresponding track, and a third box storing specific data designated by the corresponding track in the second box; a first decoder reading out a corresponding file from the storage medium and decoding and extracting a part corresponding to media data; a second decoder generating specific data by decoding depending on a type of the corresponding file; and a processor processing the data generated by the second decoder depending on a type of the corresponding file.

In further still another aspect of the present invention, a digital broadcasting receiver comprises: a storage medium receiving and storing a digital broadcasting signal including at least one file having a multimedia application format (MAF) file format constructed to include a first box indicating a type of a corresponding file, a second box including a plurality of tracks, a third box storing a plurality of data objects designated by each track in the second box, and a fourth box including data of each data object stored in the third box, and outputting track data of a data object which is requested; a first decoder requesting a specific data object with reference to the fourth box, receiving and decoding the data object output from the storage medium in accordance with the request, and extracting only a part corresponding to media data; and a second decoder decoding the data depending on the type of the corresponding file.

### ADVANTAGEOUS EFFECTS

A method for constructing a file format, and an apparatus for processing a digital broadcasting signal including a file having the file format and a method thereof in accordance with the present invention have the following advantages.

First, it is possible to construct a file format the most suitable for a type of a corresponding file.

Second, it is possible to construct files for digital multimedia broadcasting by using a MAF file format.

Third, it is possible to process files having a MAF file format in a digital broadcasting receiver.

### BRIEF DESCRIPTION OF THE DRAWINGS

FIG. 1 illustrates an example of a MAF file format structure for digital multimedia broadcasting, which is constructed in accordance with the present invention;

FIG. 2 illustrates an example of a syntax structure of a ftyp box;

FIG. 3 illustrates an example of a syntax structure of a moov box;

FIG. 4 illustrates an example of a syntax structure of a mdat box;

FIG. 5 illustrates another example of a MAF file format structure for digital multimedia broadcasting, which is constructed in accordance with the present invention;

FIG. 6 illustrates other example of a MAF file format structure for digital multimedia broadcasting, which is constructed in accordance with the present invention;

FIG. 7 illustrates an example of syntax of a meta box;

FIG. 8 illustrates an example of syntax of an iloc box;

FIG. 9 illustrates an example of syntax of an iinf box;

FIG. 10 illustrates an example of syntax of a xml box;

FIG. 11 illustrates an example of syntax of a mthd box;

FIG. 12 illustrates an example of a digital broadcasting receiver for processing a digital broadcasting signal, which includes at least one file having a MAF file format constructed for digital multimedia broadcasting in accordance with the present invention;

FIG. 13 illustrates another example of a digital broadcasting receiver for processing a digital broadcasting signal, which includes at least one file having a MAF file format constructed for digital multimedia broadcasting in accordance with the present invention;

FIG. 14 illustrates an example of a flow chart to illustrate a processing procedure of FIG. 12 and FIG. 13;

FIG. 15 illustrates another example of a digital broadcasting receiver for processing a digital broadcasting signal, which includes at least one file having a MAF file format constructed for digital multimedia broadcasting in accordance with the present invention; and

FIG. 16 illustrates an example of a flow chart to illustrate a processing procedure of FIG. 15.

### DESCRIPTION OF REFERENCE NUMERALS OF MAIN PARTS IN THE DRAWINGS

501, 701: digital broadcasting receiver

502, 702: storage medium

503, 530, 703: first decoder

504, 540, 704: second decoder

505: processor

506, 705: display unit

510: data input unit

520: parser

### BEST MODE FOR CARRYING OUT THE INVENTION

Reference will now be made in detail to the preferred embodiments of the present invention, examples of which are illustrated in the accompanying drawings. Hereinafter, a method for constructing a file format, and an apparatus for processing a digital broadcasting signal including at least one file having the file format and a method thereof will be described in detail with reference to the accompanying drawings.

To describe technical spirits of the present invention more clearly, a multimedia application format (MAF) file format will be used as an example of the file format. Also, digital multimedia data for digital multimedia broadcasting will be used as the digital multimedia data.

The MAF file format for digital multimedia broadcasting, which is constructed in accordance with the present invention, will be described below.

The MAF file format is based on an International Organization for Standardization (ISO) file format, and describes how to combine diversities of contents in respect of information for presentation in a format well defined to facilitate interchange, management, editing and presentation of contents.

The MAF file format for digital multimedia broadcasting, which is an example of the MAF file format, can support various service types such as terrestrial digital multimedia broadcasting and satellite digital multimedia broadcasting. Also, each service can support main audio/video contents and auxiliary data.

Hereinafter, as contents for digital multimedia broadcasting, data for audio dedicated broadcasting, data for interleaved audio and video transport streams, and data for data broadcasting contents will be described below.

Also, the MAF file format for digital multimedia broadcasting includes a file format structure for single digital multimedia broadcasting contents and a file format structure for multiple digital multimedia broadcasting contents. Hereinafter, for convenience of description, the file format structure for single digital multimedia broadcasting contents will exemplarily be described. However, it will be apparent that the file format structure for multiple digital multimedia broadcasting contents can also be used.

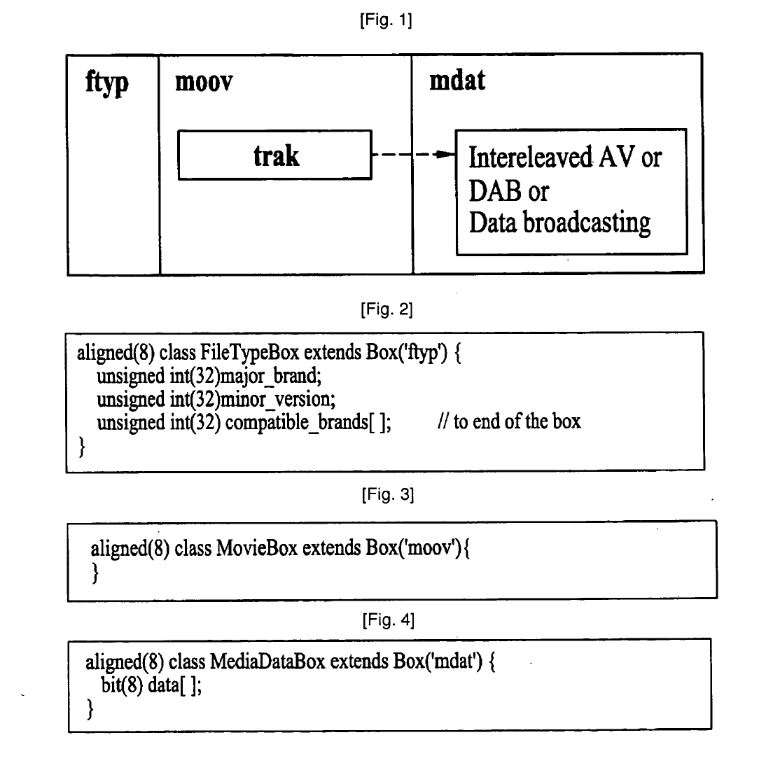

FIG. 1 illustrates an example of the MAF file format structure for digital multimedia broadcasting, which is constructed in accordance with the present invention.

The MAF file format structure for digital multimedia broadcasting according to the present invention is generally expressed by a box structure, each of which can be defined in a corresponding standardization.

The file format basically means a file format defined to be generally used without being limited to a specific network protocol or hardware.

Also, the box can mean a specific part defined by a unique box type and length in the file format. At this time, the box can be divided into a general box and a container box. The general box includes data according to actual corresponding purpose of use while the container box includes other types of boxes and is to contain and gather a set of associated boxes. Although the container box can include other types of boxes for grouping, it can maintain full size and name only of the grouped box.

Hereinafter, main boxes in the MAF file format structure constructed in accordance with the present invention will be described as follows. For convenience of description, name of each box will be displayed with a bold font, and name of each field which constitutes syntax of the box will be displayed with big quotation marks.

Referring to FIG. 1, the MAF file format structure for digital multimedia broadcasting, which is constructed in accordance with the present invention, can include a file type box ftyp box, a movie box moov box, and a media data box mdat box.

Each of the boxes will be described in detail with reference to the accompanying drawings.

First of all, the ftyp box will be described with reference to FIG. 2.

The ftyp box means a file type box and is to display information for generation purpose (or type) of a corresponding file format, information for version, or information for compatible brand.

Accordingly, the ftyp box in the MAF file format structure for digital multimedia broadcasting in connection with the present invention can display information for a type of corresponding digital multimedia broadcasting, such as terrestrial digital multimedia broadcasting, satellite digital multimedia broadcasting, and European-oriented terrestrial digital multimedia broadcasting.

An example of syntax for the ftyp box illustrated in FIG. 1 includes a plurality of fields.

Among the plurality of fields constituting syntax of the ftyp box, “major_brand” field represents a brand identifier for indicating the MAF file format for digital multimedia broadcasting having version.

For example, if a value of the “major_brand” field is equal to ‘td01,’ this field can represent terrestrial digital multimedia broadcasting having a specific type. If a value of the “major_brand” field is equal to ‘td02,’ this field can represent terrestrial digital multimedia broadcasting having another type different from that of ‘td01.’ Also, if a value of the “major_brand” field is equal to ‘sd01,’ this field can represent satellite digital multimedia broadcasting having a specific type.

Next, “minor_version” field is an informative integer having information for minor version of the “major_brand” field. In other words, a value of the “minor_version” field can indicate detailed version of digital multimedia broadcasting dependent upon the value of “major_brand” field.

For example, when the value of the “major_brand” field is equal to ‘td01,’ version of terrestrial digital multimedia broadcasting having a corresponding type can be described. At this time, a value of the version can be divided into four fields, for example. In this case, the first field can represent a major version according to the “major_brand” field, and the second field can represent a minor version according to the “major_brand” field. The other fields can be reserved for later use.

Also, “compatible_brands” field means a set of lists, and represents lists of brands compatible with a current file.

Next, the moov box will be described with reference to FIG. 3.

The moov box means a movie box, and is a container box that can include meta data boxes related to a real movie. For example, the moov box can describe presentation of a scene which includes at least one trak box. Also, the moov box does not have its information, and can serve to group respective boxes therein.

The moov box can include iods box and at least one trak box.

The iods box means an initial object descriptor box, and represents a box that can store iod contents included in MPEG-4 streams.

The trak box means a track box, is a container box that can store information of one track for presentation, and can include description for one media.

Also, the trak box can include description for one media, and one media in each trak box can include contents not related to main data, information of digital audio broadcasting, information of interleaved audio and video transport streams, and information of data broadcasting. Moreover, the trak box can indicate main data.

The trak box means a track box, and is a container box that can store information of one track for presentation. For example, trak(bifs) box can represent a track having binary format for scene (BIFS) data, and trak(od) box can represent a track having object descriptor data. Namely, if one track called audio is stored, all kinds of information of audio can be stored in each box, and the trak box serves to group the information.

Also, the trak box can indicate main data.

The trak box can include mdia box therein.

The mdia box means a media box, and is a container box that includes information of media. The mdia box can include stbl box which is a sample table box having time and reference information of media inside the track. Accordingly, timing of samples can be adjusted by using the time and reference information inside the stbl box. In other words, the trak box can support timing information such as edtl and stbl boxes for synchronization with other media of another trak box. However, since information of interleaved audio and video transport streams among media includes timing information in advance, the trak box may not include a separate box for synchronization information.

The mdat box will be described with reference to FIG. 4.

The mdat box means a media data box, and is a box that stores real streams. Since the stored streams do not have any information, position and information of current streams can be obtained by other meta or moov box.

In other words, the aforementioned MAF file format structure according to the present invention includes ftyp box for indicating a type of digital multimedia broadcasting such as terrestrial digital multimedia broadcasting or satellite digital multimedia broadcasting, includes one trak box for including any one of audio dedicated broadcasting, transport streams, and data broadcasting contents in the moov box included in the ftyp box, and includes data for interleaved AV, audio dedicated broadcasting or data broadcasting contents, displayed in the trak box through the mdat box.

Accordingly, a transmitter can forward digital multimedia broadcasting contents, which are constructed using the MAF file format structure for digital multimedia broadcasting in accordance with the present invention, by using streaming through Internet or a storage medium, and a receiver can store the contents through reception or copying. Also, according to the present invention, contents can be reproduced by using a simple MAF file format structure.

The MAF file format structure for data of audio dedicated broadcasting, data of interleaved audio and video transport streams, and data of data broadcasting contents has been described as above.

### MODE FOR THE INVENTION

Hereinafter, an example of an MAF file format structure of data for data broadcasting of digital multimedia broadcasting using meta data will be described below, wherein the digital multimedia broadcasting includes various data broadcasting services.

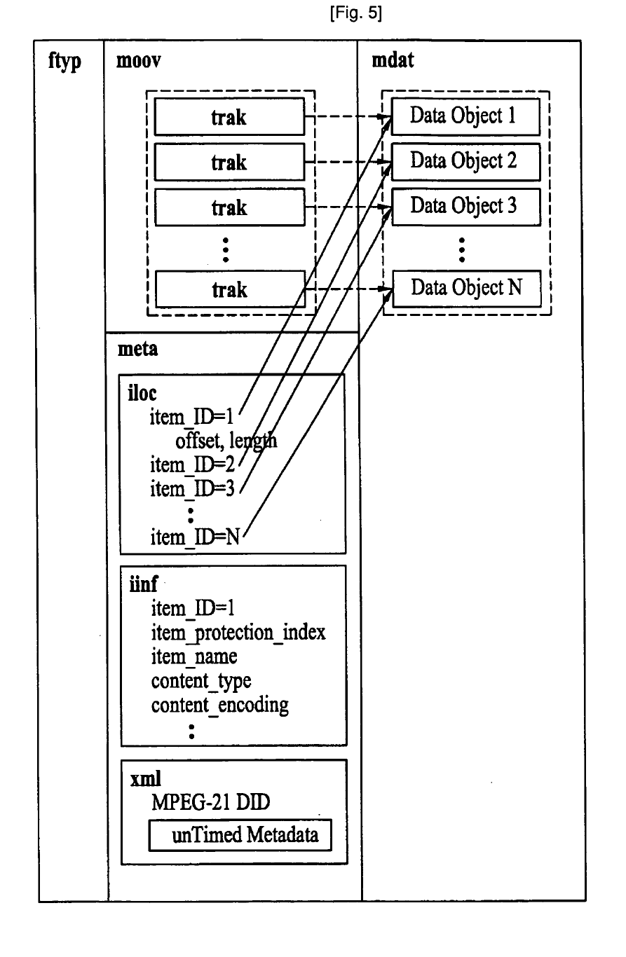

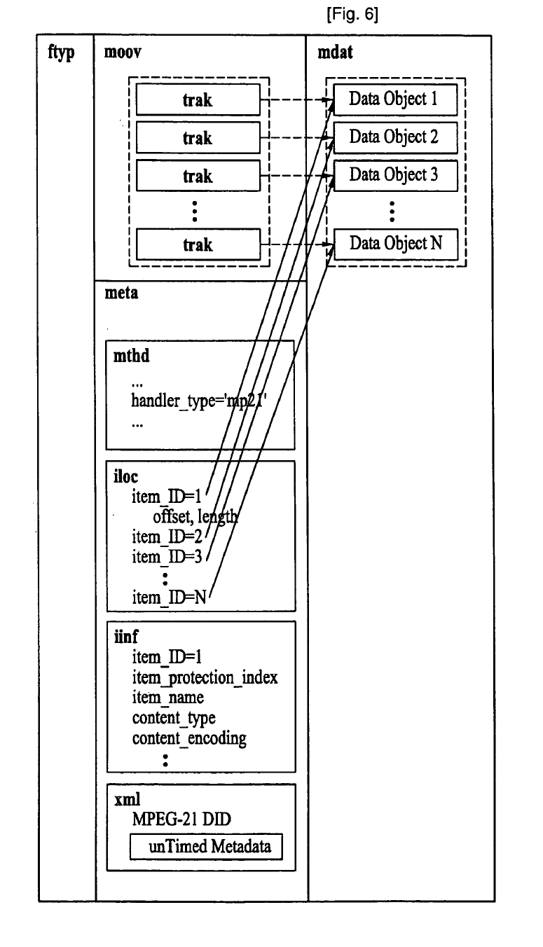

FIG. 5 illustrates another example of the MAF file format structure for digital multimedia broadcasting, which is constructed in accordance with the present invention, and FIG. 6 illustrates other example of the MAF file format structure for digital multimedia broadcasting, which is constructed in accordance with the present invention.

The file formats of FIG. 5 and FIG. 6 do not have any audio/video streams, and can include only data for data broadcasting contents.

Also, in describing the MAF file format structure of FIG. 5 and FIG. 6, a part duplicated in the part described with reference to FIG. 1 will be quoted from the description of FIG. 1.

Accordingly, the following description will be based on the difference from FIG. 1.

Most of data for data broadcasting contents are comprised of a plurality of data objects.

Referring to FIG. 5 and FIG. 6, the ftyp box among boxes constituting the MAF file format structure represents a type of digital multimedia broadcasting, and the moov box corresponds to each box which stores real data objects in the mdat box including at least one trak box for data broadcasting.

At this time, the data objects mean a set of significant data in data broadcasting for digital multimedia broadcasting. Also, the data objects can be indicated by each trak box.

The meta box will be described as follow. The meta box is a container box for boxes related to meta data. The meta box can include iloc box, iinf box, xml box, and mthd box (FIG. 6). At this time, the meta data can provide various kinds of information such as position and size with respect to track from each trak box.

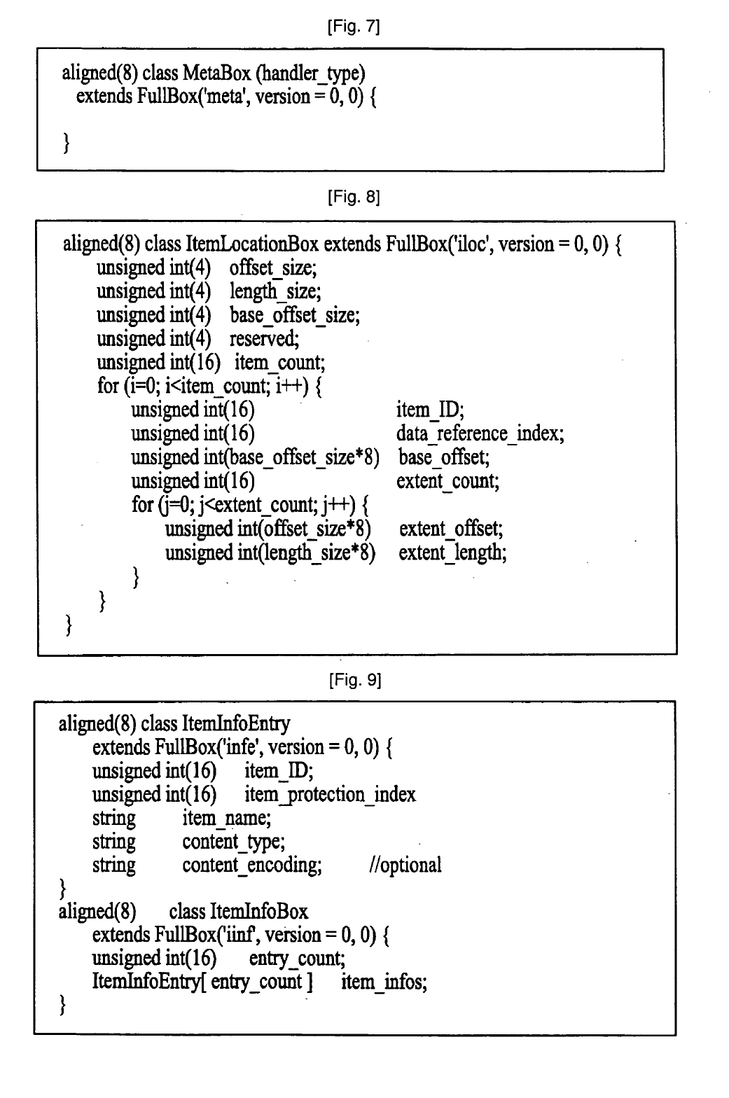

FIG. 7 illustrates an example of syntax of the meta box.

Hereinafter, each box in the meta box will be described.

FIG. 8 illustrates an example of syntax of the iloc box.

The iloc box means an item location box, and is a box representing where streams referred to by meta data are located in the file.

Syntax of the iloc box will be described with reference to FIG. 8.

An “offset_size” field designates length of byte of an “offset” field. A “length_size” field designates length of a “length” field. A “base_offset_size” field designates length of a “base_offset” field. An “item_count” field designates the number of resources of an array which will be described later. An “item_ID” field is a random integer representing name for resources used when referring to URL, for example. A “data_reference_index” field represents data references in the data information box and is an index based on 0 or 1. The “base_offset” field provides a basic value for offset calculation within the referred data. If a value of the “base_offset_size” field is equal to ‘0,’ the “base_offset” field has ‘0.’

An “extent_count” field provides the number of extents by counting if a corresponding resource is fragmented. At this time, the count value is greater than at least 1. An “extent_offset” field provides indispensable offset from start of a file which includes a corresponding item. If a value of the “offset_size” field is equal to ‘0,’ the offset has ‘0.’ An “extent_length” field provides indispensable length of a corresponding meta data item. If a value of the “length_size” field is equal to ‘0,’ the length of the item means a length of the referred file.

FIG. 9 illustrates an example of syntax of the iinf box.

The iinf box means an item information box, and is a box which includes real meta data of contents of each track.

Each field will be described with reference to FIG. 9.

An “item_ID” field includes ID of an item defined in information, which will be described later, or 0 for primary resource such as any one xml box. An “item_protection_index” field designates ‘0’ in case of one item which is not protected while designates index of a box, which defines a protection method of the item, in other cases. An “item_name” field is a text row which includes a symbolic name of the item. A “content_type” field is a multipurpose internet mail extension (MIME) type for the item. A “content_encoding” field is a text row used to indicate a method for decoding a binary file when the binary file is encoded. An “entry_count” field provides number count of entries in an array which will be described later.

In other words, the iloc box and the iinf box describe position and information of each item inside the mdat box.

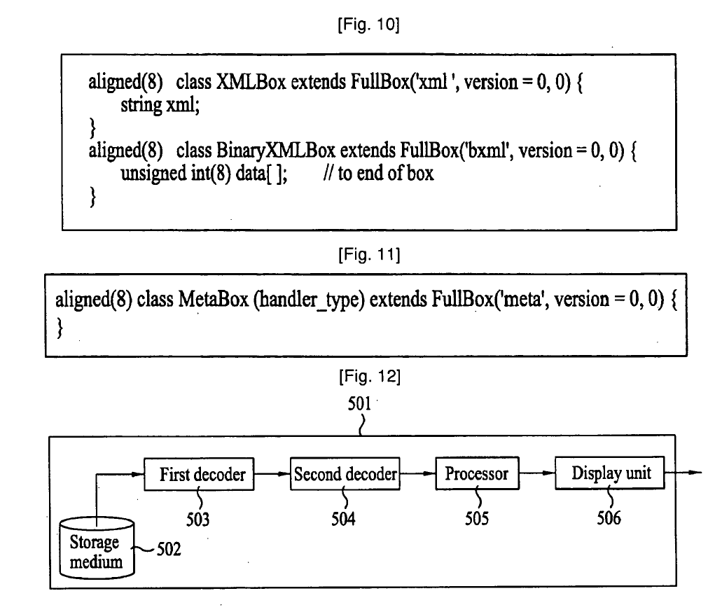

FIG. 10 illustrates an example of syntax of the xml box.

A structure for items inside the iloc box and the iinf box has limitation in depicting items in flat and detail.

In this respect, in order to support flexibility of the file format, the xml box can be used. At this time, the xml box can support either untimed text such as MPEG-21 DID (Digital Item Declaration), IPMP (Intellectual Property Management and Protection), MPEG-7, and TV anytime, or binary data.

The MPEG-21 DID meta data can be included in the xml box, and can include meta data such as IPMP, MPEG-7 and TV anytime and meta data such as script and source code inside a hierarchical structure. Accordingly, the MPEG-21 DID meta data can support description for items.

Accordingly, a menu user interface (UI) of contents for digital multimedia broadcasting, which is stored or will be stored in the xml box by using the aforementioned meta data, can be constructed.

Referring to FIG. 5, there is the mdat box in the ftyp box called digital multimedia box, wherein the mdat box includes n data objects. A file structure for data broadcasting can be defined by constructing the MAF file format structure with the meta box which includes iloc box, iinf box and xml box, wherein these boxes are meta data of each data object in the mdat box.

FIG. 11 illustrates an example of syntax of the mthd box. FIG. 11 relates to FIG. 6 which adds the mthd box to the meta box in FIG. 5.

According to the present invention, it is not necessary to change a type of a container box or add an integer value for meta data to a handler type by including the mthd box in the meta box as illustrated in FIG. 11.

In other words, for the meta data, the mthd (meta handler) box to which the handler box has been extended is used in the present invention as follows.

At this time, a “handler_type” field of the mthd box defines several types of meta data used in the MAF file format for digital multimedia broadcasting.

For example, the following values can be defined. ‘mp7’ represents that the type of meta data such as MPEG-7 has been used, ‘TVA’ represents that the type of meta data of TV-anytime which is non-standard of MPEG has been used, and ‘mp21’ represents that the type of meta data is defined by meta data standard of MPEG-21. In FIG. 11, the mthd box is randomly named for description of the present invention, and its contents can be changed.

Accordingly, by constructing an adaptive MAF file format structure for data broadcasting in accordance with the present invention, the transmitter can transmit information of each box inside the trak box and the meta box at a desired quantity equivalent to the number of data objects for data broadcasting, and the receiver can receive and store a digital broadcasting signal including the MAF file format structure. Also, the transmitter can use desired data object by directly approaching to the data object using the meta data.

The MAF file format structure for contents for any one digital multimedia broadcasting of audio dedicated broadcasting, transport streams, and data broadcasting contents, which can be transmitted through each channel for digital multimedia broadcasting, and how to construct the MAF file format structure for data of data broadcasting contents have been described as above.

Hereinafter, a digital broadcasting receiver which receives and processes a digital broadcasting signal including the aforementioned MAF file format structure for digital multimedia broadcasting in accordance with the present invention will be described.

FIG. 12 illustrates an example of a digital broadcasting receiver for receiving and processing a MAF file format constructed for digital multimedia broadcasting in accordance with the present invention.

A digital broadcasting receiver 501 of FIG. 12 includes a storage medium 502, a first decoder 503, a second decoder 504, a processor 505, and a display unit 506.

The storage medium 502 stores files having the MAF file format constructed as above for digital multimedia broadcasting and then outputs each file. At this time, the files include files having the MAF file format constructed for audio dedicated broadcasting, transport streams, and data broadcasting contents.

The first decoder 503 is a file decoder for decoding files having the MAF file format constructed as above, and reads out corresponding files, i.e., files having the MAF file format from the storage medium 502, and decodes and extracts a part only corresponding to media data among the read out files.

The second decoder 504 generates data by decoding depending on properties of the corresponding files decoded by and extracted from the first decoder 503.

The processor 505 receives the data generated from the second decoder 504 and processes the data depending on properties of the corresponding files.

The display unit 506 outputs each of the processed data depending on properties of the corresponding files.

In connection with the present invention, if the files having the MAF file format are for audio dedicated broadcasting, the second decoder 504 serves as an audio decoder, especially MPEG-1 audio decoder, and can generate PCM data by decoding the files for audio dedicated broadcasting, extracted from the first decoder 503 and compressed in MPEG-1 layer 2 (MUSICAM) type. The generated PCM data are processed by the audio processor 505 and then output through a speaker 506 which is a display device.

If the files are for transport streams, the second decoder 504 decodes audio and video data multiplexed in the transport streams after demultiplexing the audio and video data through a demultiplexer (not shown).

For example, in case of the audio data, the MPEG-4 audio decoder 504 decodes the extracted audio data to be suitable for MPEG-4 AVC (Advanced Video Coding) standard. The audio processor 505 receives the decoded audio data, processes the received data, and outputs the corresponding data through the speaker 506.

Unlike the audio data, in case of the video data, the MPEG-4 video decoder 504 decodes the extracted video data to be suitable for MPEG-4 AVC (Advanced Video Coding) standard. The video processor 505 receives the decoded video data, processes the received data, and outputs RGB data through a screen 506 which is a display device.

Furthermore, if the files having the MAF file format are for data broadcasting contents, for example, BWS (Broadcast Web Site), the second decoder 504 splits the extracted BWS data in an object unit. At this time, in case of the data broadcasting contents as above, an object storage unit (not shown) can further be provided to store the data therein, which are split by the second decoder 504 in an object unit. After the data are stored in the object storage unit, they are displayed through a web browser (not shown) which allows respective data objects to be displayed properly by analyzing a document designated in HTML type.

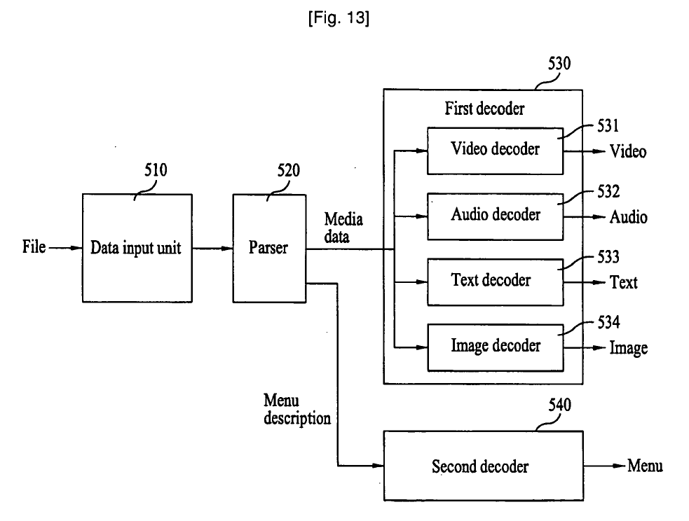

FIG. 13 illustrates another example of the digital broadcasting receiver for receiving and processing the MAF file format constructed for digital multimedia broadcasting in accordance with the present invention.

A digital broadcasting receiver of FIG. 13 includes a data input unit 510, a parser 520, a first decoder 530, and a second decoder 540.

The data input unit 510 receives files having the MAF file format constructed as above.

The parser 520 parses each file received from the data input unit 510. For example, the parser 520 parses a media data part inside each file and a menu description part for the media data part, and transmits each part to the corresponding decoder.

The first decoder 530 receives and decodes the media data part of each file input from the parser 520 and is processed depending on properties of the corresponding media data part. For example, if the corresponding media data part corresponds to video data, a video decoder 531 decodes the media data part. If the corresponding media data part corresponds to audio data, an audio decoder 532 decodes the media data part. In this way, if the corresponding media data part corresponds to text data, a text decoder 533 decodes the media data part. Likewise, if the corresponding media data part corresponds to image data, an image decoder 534 decodes the media data part.

The second decoder 540 receives and decodes the menu description part of each file input from the parser 520, and outputs the decoded part to a menu. At this time, although not shown, the decoded description part may be output by rendering. Also, the second decoder 540 can receive and transmit data from and to the first decoder 530.

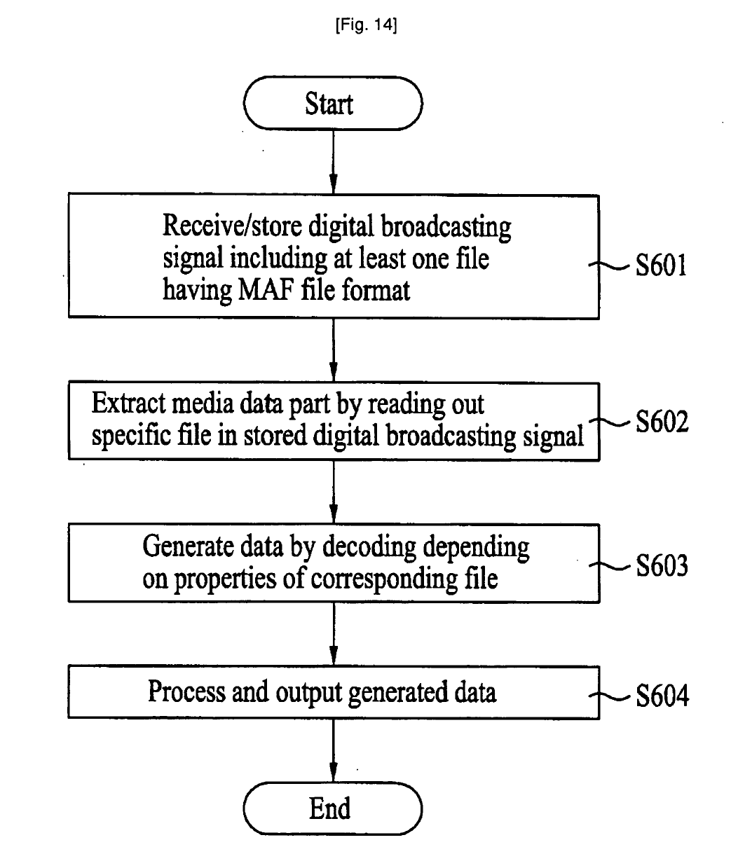

FIG. 14 illustrates an example of a flow chart to illustrate the processing procedure of FIG. 12 to FIG. 13.

A digital broadcasting signal including at least one file having the MAF file format constructed as shown in FIG. 1 is received and stored (S601).

A specific file in the stored digital broadcasting signal is read out, and only a media data part from the specific file is decoded and extracted (S602). Then, the extracted media data part is decoded depending on properties of the corresponding file to generate data (S603), and the generated data is processed and displayed (S604).

As described above, the menu description is first provided by decoding so that the corresponding file selected from the user can be decoded as above to display data.

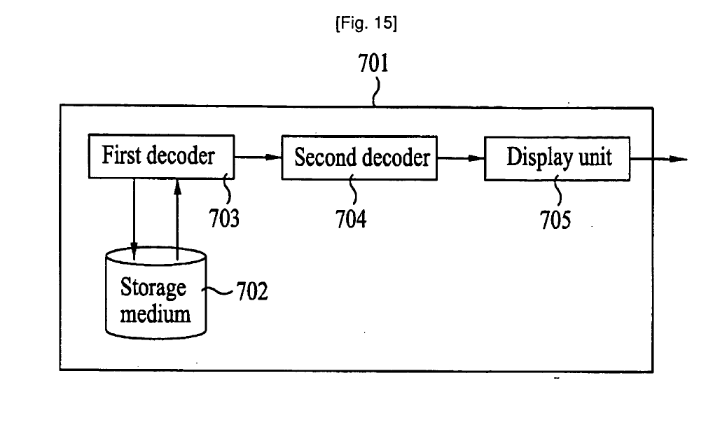

FIG. 15 illustrates another example of the digital broadcasting receiver for receiving and processing a digital broadcasting signal including the MAF file format structure constructed for digital multimedia broadcasting in accordance with the present invention.

A digital broadcasting receiver 701 of FIG. 15 includes a storage medium 702, a first decoder 703, a second decoder 704, and a display unit 705.

Hereinafter, for convenience of description, the transmitter transmits a digital broadcasting signal including point of interest (POI) files of TPEG and files having the MAF file format illustrated in FIG. 5 and FIG. 6 in digital multimedia broadcasting.

The POI is a kind of a service of TPEG standard in digital multimedia broadcasting, and is to display information of a specific place and point in which the user is interested. For example, if various kinds of information such as location, photo, menu, and telephone number in respect of a famous restaurant in a specific place are needed, a category is defined in the POI, and the various kinds of information are included in category information divided into car, sightseeing, lodging, restaurant, bank, and so on.

The storage medium 702 receives and stores the POI files of the TPEG. As described above, in case of the files having the structure illustrated in FIG. 5 and FIG. 6, the storage medium 702 can access only a desired data object among at least one or more data objects.

Accordingly, if the first decoder 703 transmits an item identifier of a desired data object with reference to meta data, the storage medium 702 transmits track data including the corresponding data object. The first decoder 703 receives and reads out the track data to decode and output only the part corresponding to media data. At this time, the track data could be each category of the POI files stored per category, and a user who constructs a receiver can randomly designate an operation if there is no operation designated by xml.

The second decoder 704 receives and decodes the POI data being output from the first decoder 703.

The display unit 705 outputs the POI data decoded by the second decoder 704.

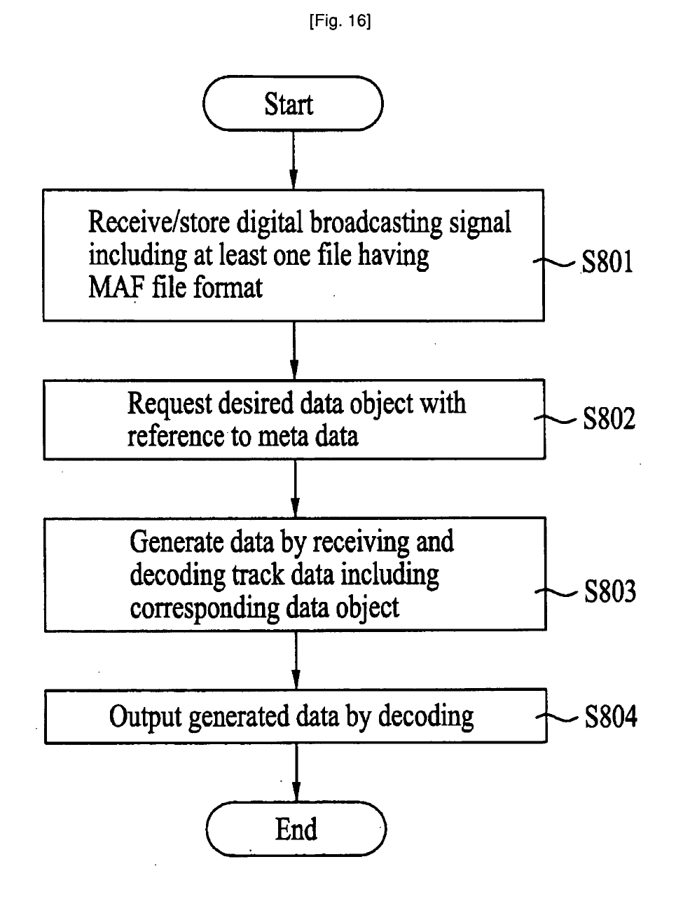

FIG. 16 illustrates an example of a flow chart to illustrate the processing procedure of FIG. 15.

A digital broadcasting signal including each file having the MAF file format constructed as shown in FIG. 5 and FIG. 6 is received and stored (S801).

A desired data object is requested with reference to meta data (S802). Then, track data related to the corresponding data object is received and decoded in accordance with the request to generate data (S803).

The generated data is decoded and output (S804).

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

As described above, according to the method for constructing a file format, and an apparatus for processing a digital broadcasting signal including a file having the file format and a method thereof in accordance with the present invention, it is possible to construct a file format most suitable for a type of a corresponding file, and it is possible to construct files for digital multimedia broadcasting by using a MAF file format structure. Also, it is possible to process files having the MAF file format in a digital broadcasting receiver.

1. A method for constructing a multimedia application format (MAF) file format, the MAF file format comprising a plurality of boxes, wherein the plurality of boxes include a first box indicating a type or version of a file for the file format, a second box including at least one track box and describing presentation of a scene including the track box, the track box including description for one media, and a third box including real contents described by each track box.

2. The method of claim 1, wherein the first box includes first information representing a brand identifier indicating a corresponding MAF file format and its version, and second information representing detailed version of the first information, the second information including at least one of information indicating major version of the first information and information indicating minor version of the first information.

3. The method of claim 1, wherein the real contents include at least one of digital audio broadcasting contents, interleaved audio/video broadcasting contents, and data broadcasting contents.

4. A method for constructing a multimedia application format (MAF) file format, the MAF file format comprising a plurality of boxes, wherein the plurality of boxes include a first box indicating a type or version of a file for the file format, a second box including a plurality of track boxes and describing presentation of a scene including the plurality of track boxes, the track boxes including description for one media, and a third box including a plurality of objects described by each track box in the second box.

5. The method of claim 4, further comprising a fourth box including meta data of each data object included in the third box.

6. The method of claim 5, wherein the fourth box includes at least one of a fifth box describing location of each data object, a sixth box describing information of each data object, and a seventh box providing information included in the fifth box and the sixth box in a format of xml.

7. A method for processing a digital broadcasting signal, comprising:
receiving and storing a digital broadcasting signal including at least one file having a multimedia application format (MAF) file format constructed to include a first box indicating a type or version of a corresponding file, a second box including at least one track and describing presentation of a scene including a corresponding track, and a third box storing specific data designated by the corresponding track in the second box;
reading out a desired file from the stored files and decoding and extracting media data in the corresponding file;
generating specific data by decoding depending on properties of the extracted media data; and
processing and outputting the generated specific data.

8. The method of claim 7, wherein the specific data include PCM data, RGB data, and data objects.

9. The method of claim 8, wherein the data objects have a format of HTML.

10. A method for processing a digital broadcasting signal, comprising:
receiving and storing a digital broadcasting signal including at least one file having a multimedia application format (MAF) file format constructed to include a first box indicating a type or version of a corresponding file, a second box including a plurality of tracks and describing presentation of a scene including each track, a third box storing a plurality of data objects designated by each track in the second box, and a fourth box including meta data of each data object stored in the third box;
requesting a specific data object in the stored files with reference to the meta data in the fourth box;
generating specific data by receiving the specific data object according to the request; and
decoding and outputting the generated specific data.

11. The method of claim 10, wherein the fourth box includes at least one of a fifth box indicating where streams referred to by the meta data are located in the files, a sixth box including real meta data of contents of each track in the second box, and a seventh box supporting description of the fifth box and the sixth box.

12. The method of claim 11, wherein the seventh box supports untimed text or binary data.

13. The method of claim 10, wherein the third box is stored in a unit of data object or category.

14. A digital broadcasting receiver comprising:
a storage medium receiving and storing a digital broadcasting signal including at least one file having a multimedia application format (MAF) file format constructed to include a first box indicating a type or version of a corresponding file, a second box including at least one track and describing presentation of a scene including a corresponding track, and a third box storing specific data designated by the corresponding track in the second box;
a first decoder reading out a corresponding file from the storage medium and decoding and extracting a part corresponding to media data;
a second decoder generating specific data by decoding depending on a type of the corresponding file; and
a processor processing the data generated by the second decoder depending on a type of the corresponding file.

15. The digital broadcasting receiver of claim 14, further comprising a display unit outputting the processed data.

16. The digital broadcasting receiver of claim 14, further comprising a demultiplexer demultiplexing interleaved audio/video if the media data in the corresponding file relate to the interleaved audio/video.

17. The digital broadcasting receiver of claim 14, further comprising a storage unit storing data objects if the type of the corresponding file relates to data broadcasting.

18. A digital broadcasting receiver comprising:
a storage medium receiving and storing a digital broadcasting signal including at least one file having a multimedia application format (MAF) file format constructed to include a first box indicating a type of a corresponding file, a second box including a plurality of tracks, a third box storing a plurality of data objects designated by each track in the second box, and a fourth box including data of each data object stored in the third box, and outputting track data of a data object which is requested;
a first decoder requesting a specific data object with reference to the fourth box, receiving and decoding the data object output from the storage medium in accordance with the request, and extracting only a part corresponding to media data; and
a second decoder decoding the data depending on the type of the corresponding file.

19. The digital broadcasting receiver of claim 18, further comprising a display unit outputting a menu constructed with reference to the decoded data or meta data in the fourth box.

20. The digital broadcasting receiver of claim 18, wherein the second decoder is a TPEG decoder if the type of the corresponding file is a TPEG service.
